(19) United States
(12) Patent Application Publication
(10) Pub. No.: US 2015/0165569 A1
(43) Pub. Date: Jun. 18, 2015

(54) REPAIR OF TURBINE ENGINE COMPONENTS USING WATERJET ABLATION PROCESS

(71) Applicants: Petya M. Georgieva, Oviedo, FL (US); Elvira V. Anoshkina, Winter Springs, FL (US)

(72) Inventors: Petya M. Georgieva, Oviedo, FL (US); Elvira V. Anoshkina, Winter Springs, FL (US)

(21) Appl. No.: 14/132,548

(22) Filed: Dec. 18, 2013

(51) Int. Cl. B23P 6/04; B23K 37/00; B23K 31/02; B23K 1/00; B24C 1/04

(52) U.S. Cl. CPC B23P 6/045; B23K 1/0018; B24C 1/04; B23K 31/02; B23K 37/00

(57) ABSTRACT

A waterjet ablation process is performed to remove a volume of material from a service area of a component, the volume of material including at least one defect and any oxides and contaminants located at the service area. After performing the waterjet ablation process, the service area of the component is repaired by a welding or brazing process to restore material to the service area. The component is put into service in an engine without requiring affixation of a replacement coupon to the component.

### FIELD OF THE INVENTION

The present invention relates to servicing a component for use in a turbine engine using a waterjet ablation process to remove a volume of material from a service area of the component.

### BACKGROUND OF THE INVENTION

In a turbomachine, such as a gas turbine engine, air is pressurized in a compressor section then mixed with fuel and burned in a combustion section to generate hot combustion gases. The hot combustion gases are expanded within a turbine section of the engine where energy is extracted from the combustion gases to power the compressor section and to produce useful work, such as turning a generator to produce electricity.

The hot combustion gases created in the combustion section travel through a series of turbine stages within the turbine section. A turbine stage may include a row of stationary airfoil assemblies, i.e., vanes, followed by a row of rotating airfoil assemblies, i.e., turbine blades, where the turbine blades extract energy from the hot combustion gases for powering the compressor section and providing output power.

One type of turbine engine component, e.g., a turbine blade, comprises an airfoil extending from a radially inner platform at a root end to a radially outer portion of the airfoil, and includes opposite pressure and suction sidewalls meeting at leading and trailing edges of the airfoil. After periods of use, it has been found that areas of the component become damaged, i.e., cracked, due to overheating and oxidation, such that repair/replacement procedures are required.

### SUMMARY OF THE INVENTION

In accordance with a first aspect of the present invention, a method is provided for servicing a component used in a turbine engine to remove at least one defect from the component. A waterjet ablation process is performed to remove a volume of material from a service area of the component, the volume of material including at least one defect and any oxides and contaminants located at the service area. After performing the waterjet ablation process, the service area of the component is repaired by a welding or brazing process to restore material to the service area. The component is put into service in a turbine engine without requiring affixation of a replacement coupon to the component.

The waterjet ablation process may remove the at least one defect from the service area while simultaneously cleaning the service area.

The component may comprise a platform from which at least one rotatable turbine blade extends, and the at least one defect may comprise at least one crack extending into the platform. The at least one crack may be located proximate to a fillet area located at a junction between the platform and the respective turbine blade.

The volume of material removed from the service area may be controlled during the waterjet ablation process within tolerances of about +/−0.001 inch, and may be controlled such that it follows a direction of propagation of the at least one defect into the component.

After performing the waterjet ablation process, there may not be a need to perform any surface preparation to the service area before repairing the service area of the component.

Parameters of a plurality of components used in turbine engines may be analyzed and stored, and a particular waterjet ablation process to be performed may be selected based on the type of component to be serviced, wherein a controller may automatically perform the particular waterjet ablation process according to the stored parameters for the component to be serviced. Coordinates corresponding to the volume of material to be removed from the service area of the component being serviced may be input to the controller, and the stored parameters of the component being serviced may be used by the controller during the step of repairing the service area of the component to restore material to the service area.

Welding or brazing material restored to the service area and any surface coatings applied to the component may be the only material restored to the component after the waterjet ablation process is performed.

The waterjet ablation process may be performed along an orientation and direction of a crack, wherein the volume of material removed from the service area includes the entire crack, and at least a portion of the crack orientation is at an angle transverse to a radial direction.

The volume of material removed by the waterjet ablation process may comprise a volume of material extending from an outer surface of the component toward but not up to an inner surface of the component such that a structural integrity of the component is maintained after the waterjet ablation process is performed.

The service area may be located at an outlet of a film cooling hole formed in an outer surface of the component.

In accordance with a second aspect of the present invention, a system is provided for servicing a component used in a turbine engine to remove at least one defect from the component. The system comprises a computer memory that stores parameters corresponding to a plurality of turbine engine components, a waterjet ablation device for removing a volume of material from a service area of a component being serviced, the volume of material including at least one defect and any oxides and contaminants located at the service area, and a controller in communication with the computer memory that causes the waterjet ablation device to perform a particular waterjet ablation process on the component being serviced based on the stored parameters from the computer memory for the component being serviced.

The system may further comprise an input device in communication with the controller, the input device configured to receive coordinates corresponding to the volume of material to be removed from the service area.

The system may also comprise a repair device comprising a welding or brazing device, the repair device configured to restore material to the service area after the volume of material is removed by the waterjet ablation device. Welding or brazing material restored to the service area by the repair device and any surface coatings applied to the component may be the only material restored to the component after the volume of material is removed from the service area by the waterjet ablation device. The component may be put into service in a turbine engine without requiring affixation of a replacement coupon to the component, and no additional surface preparation may be necessary for the service area after the waterjet ablation device removes the volume of material from the service area and before the repair device restores material to the service area. The system may further comprise an input device in communication with the repair device configured to receive coordinates of the material to be restored to the service area, wherein the coordinates of the material to be restored to the service area may be used by the welding or brazing device to restore material to the service area.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a perspective view of an airfoil assembly to be serviced according to an embodiment of the invention;

FIG. 2 is a cross sectional view taken through line 2-2 in FIG. 1;

FIG. 2A is an enlarged view of a portion of FIG. 2 showing a service area including a defect to be serviced in accordance with an aspect of the invention;

FIGS. 3 and 3A are views similar to FIGS. 2 and 2A but showing the service area after a waterjet ablation process and a repair process have been performed;

FIG. 4 is a block diagram of a system used for servicing a component in a turbine engine in accordance with the invention; and

FIG. 5 is a block diagram of a data processing system used in accordance with the invention.

### DETAILED DESCRIPTION OF THE INVENTION

In the following detailed description of a preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

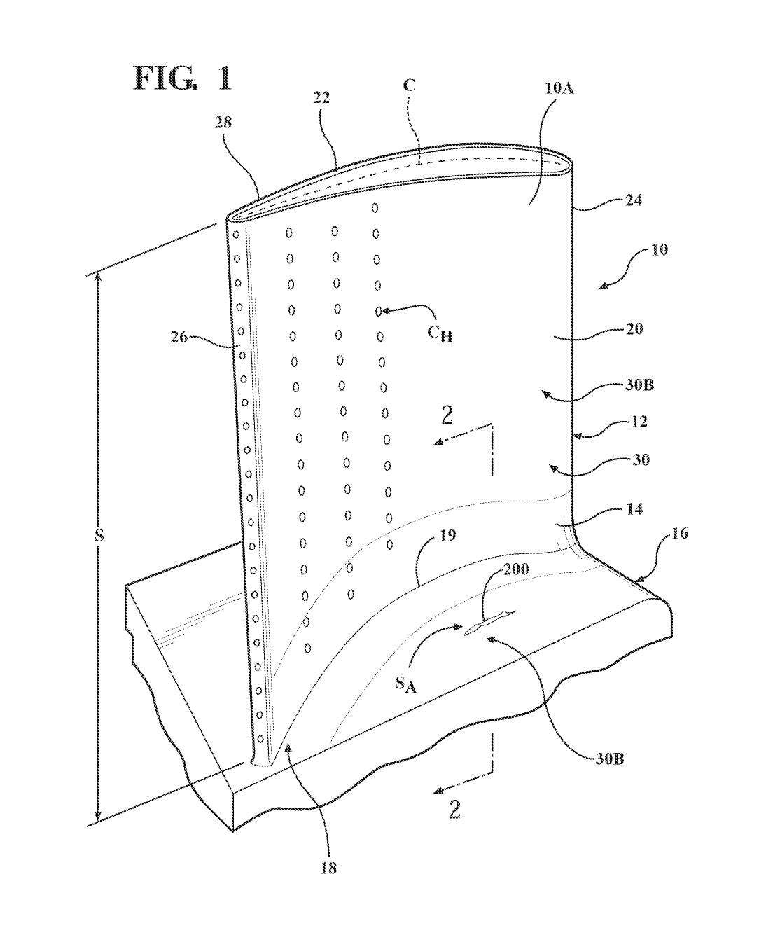

Shown in FIG. 1 is an airfoil assembly 10, e.g., a turbine blade assembly, adapted for use in a turbine engine (not shown). When assembled in the turbine engine, the airfoil assembly 10 is incorporated into one of a plurality of rows of rotating airfoil assemblies, which rows of rotating airfoil assemblies extend circumferentially about a turbine rotor (not shown) of the engine. Hot combustion gases created in a conventional combustor assembly (not shown) are discharged into a turbine section (not shown) of the engine in which the rows of airfoil assemblies are employed. Rows of stationary airfoil assemblies (not shown), e.g., stationary vane assemblies, direct the hot combustion gases toward corresponding rows of the rotating airfoil assemblies, which rotate and cause corresponding rotation of the turbine rotor.

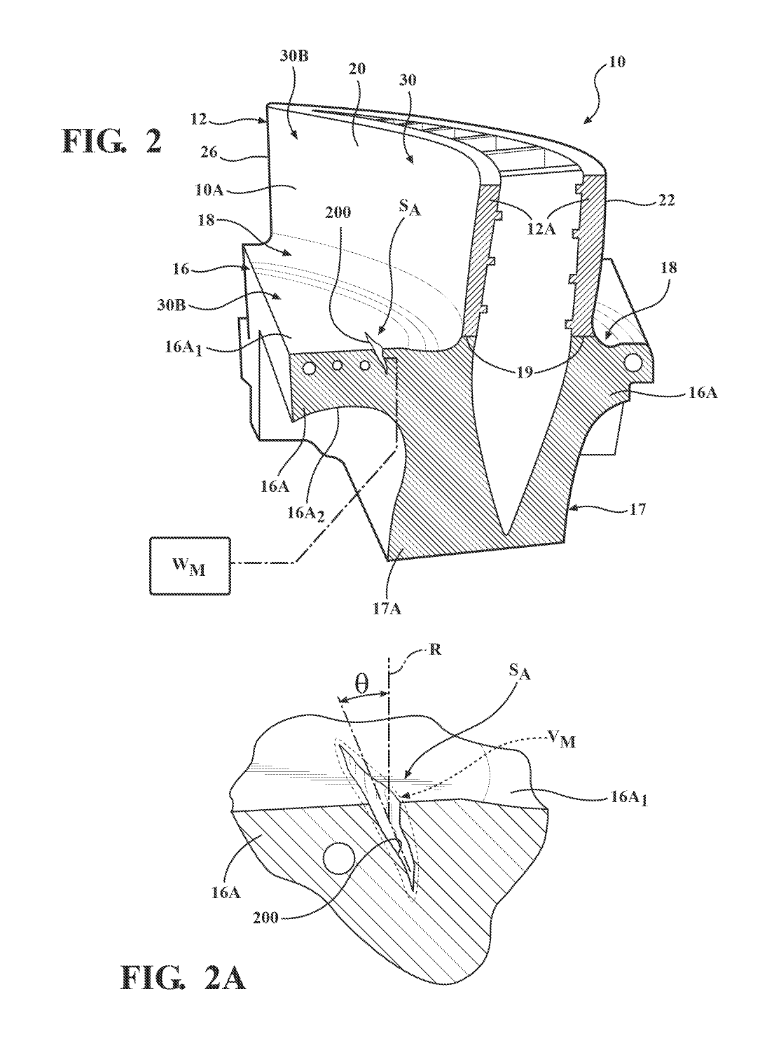

The airfoil assembly 10 shown in FIG. 1 comprises an exemplary airfoil 12. The airfoil 12 extends radially outwardly from and, in the embodiment shown, is integrally joined at a root end 14 thereof to a platform 16 of the airfoil assembly 10. The airfoil 12 is joined to the platform 16 at a fillet area 18 of the airfoil assembly 10. The fillet area 18 comprises a junction between the airfoil 12 and the platform 16 and is located at an intersection 19 between the airfoil 12 and the platform 16. The airfoil assembly 10 may further comprise a shank 17, see FIG. 2, which is integrally connected to the platform 16. The shank 17 is coupled to a root (not shown), which is adapted to be coupled to a corresponding rotor disc (not shown) forming part of the rotor. Rows of airfoil assemblies 10 are coupled to the discs so as to cause rotation of the rotor during operation of the engine, as will be apparent to those having ordinary skill in the art.

As shown in FIGS. 1 and 2, the airfoil 12 includes a generally concave pressure sidewall 20 and an opposed, generally convex suction sidewall 22. The pressure and suction sidewalls 20, 22 of the airfoil 12 converge at a first location defined at a leading edge 24 of the airfoil 12 (see FIG. 1) and at a second location defined at a trailing edge 26 of the airfoil 12 opposed from the leading edge 24. The pressure and suction sidewalls 20, 22 extend in a chordal direction C between the opposite leading and trailing edges 24, 26 of the airfoil 12, see FIG. 1. The leading and trailing edges 24, 26 extend radially and span a distance S from the root end 14 of the airfoil 12 to a tip end 28 of the airfoil 12 opposed from the root end 14, see FIG. 1.

The airfoil assembly 10 is defined by a base material 30, which base material 30 forms structural walls 12A, 16A, 17A of the airfoil 12, the platform 16, and the shank 17, see FIG. 2. The base material 30 may comprise a different material or the same material for each of the airfoil, platform, and shank structural walls 12A, 16A, 17A, and preferably comprises a high heat tolerant material capable of withstanding the high temperature environment of the turbine section of the engine. For example, the base material 30 may comprise a stainless steel based alloy or a nickel or cobalt based super alloy.

It is noted that one or more layers or coatings (not shown) may be applied over the base material 30. For example, a thermal barrier coating (TBC) and a bond coat may be applied over the base material 30, so as to provide a high heat tolerant coating over the base material 30.

During operation of the engine, cracks and/or other surface defects (hereinafter collectively referred to as “defects”) may form in the base material 30, i.e., caused by overheating and oxidation of the base material 30. One area that has been found to be prone to such defects is the platform 16, in particular proximate to the fillet area 18. A method of servicing a component for use in a turbine engine to be described herein can be utilized to remove these defects while maintaining a structural rigidity and integrity of the component.

Referring now to FIGS. 1-3A, the aforementioned method of servicing a component for use in a turbine engine, such as the airfoil assembly 10 described herein with reference to FIGS. 1, 2, and 3 is illustrated. In accordance with one aspect of the invention, the airfoil assembly 10 to be serviced includes a service area S_{A} (see FIG. 1), which may include one or more defects. The service area S_{A} illustrated in FIGS. 1, 2, and 3 is located in the platform 16 of the airfoil assembly 10 proximate to the fillet area 18, although the service area S_{A} could be located elsewhere in the airfoil assembly 10, such as, for example, at an outlet of a film cooling hole C_{H} formed in an outer surface of the airfoil assembly 10, see FIG. 1.

Initially, a waterjet ablation process is performed with a waterjet ablation machine W_{M} (see FIG. 2) to remove a volume of material V_{M} from the service area S_{A} of the airfoil assembly 10. The volume of material V_{M} includes at least one defect 200 (see FIGS. 1 and 2) and any oxides and contaminants located at the service area S_{A} around the defect 200. Removing the volume of material V_{M} removes the at least one defect 200 and any oxides and contaminants from the service area S_{A} of the airfoil assembly 10. Simultaneous with removing the at least one defect 200 and any oxides and contaminants, the service area S_{A} is cleaned by the waterjet ablation process removing the volume of material V_{M}.

In accordance with an aspect of the present invention, during the waterjet ablation process, the waterjet ablation machine W_{M} is capable of controlling the waterjet to remove the volume of material V_{M} within tolerances of about +/−0.001 inch, i.e., the volume of material V_{M} being removed from the service area S_{A} can be controlled precisely by the waterjet ablation machine W_{M}. For example, waterjet ablation machine W_{M} is capable of controlling the waterjet such that the volume of material V_{M} removed follows a direction of propagation of the defect 20. With reference to FIG. 2A, some defects 200, or, at least one or more portions thereof, may be formed in the airfoil assembly 10 at an angle θ transverse to a radial direction R, such that performing the waterjet ablation process directly in the radial direction may not be desired. In such a case, the waterjet ablation process can be controlled along an orientation and direction of the defect 200 while still removing the entire defect 200 from the airfoil assembly 10. Such control of the waterjet ablation machine W_{M} can be precisely carried out such that the angle of the waterjet is changed to follow the angle θ of defect 200 through the airfoil assembly 10. Thus, even curved and other complex-shaped defects 200 can be efficiently followed by waterjet ablation process, such that only the material necessary to remove the entire defect 200 is removed, thus maintaining the integrity of the airfoil assembly 10. This is possible, for example, by monitoring changes in materials properties of the volume of material V_{M} being removed, such as changes in oxide concentrations, changes in concentration of certain elements, and/or changes in electrical conductivity and/or resistivity.

These changes in material properties may also help in determining how deep the defect 200 penetrates into the base material 30. Thus, as another example, while the depth of the volume of material V_{M} that is removed according to the method described above may be generally constant, the depth of the volume of material V_{M} that is removed may vary between the edges of the volume of material V_{M} removed. For example, a depth of the defect 200 may vary between edges, and the volume of material V_{M} removed may vary with the depth of the defect 200. Hence, only the material necessary to remove the entire defect 200 is removed, thus maintaining the integrity of the airfoil assembly 10.

Preferably, the volume of material V_{M} removed by the waterjet ablation process comprises a volume of material V_{M} of the airfoil assembly 10 extending from an outer surface of the portion of the airfoil assembly 10 being serviced toward but not up to an inner surface thereof, such that a structural integrity of the airfoil assembly 10 is maintained after the waterjet ablation process is performed. For example, referring to FIG. 2, wherein the volume of material V_{M} is removed from the platform 16 of the airfoil assembly 10, the volume of material V_{M} removed extends from a radially outer side 16A₁ of the platform 16 toward but not up to a radially inner side 16A₂. Since the remainder of the structural wall 16A of the platform 16 is left intact, i.e., the base material 30 not included in the volume of material V_{M} removed, the structural rigidity of the airfoil assembly 10 is not significantly compromised by the waterjet ablation process described herein.

During the waterjet ablation process, by removing the volume of material V_{M} in which the defects 200 are located, the defects 200 themselves are removed, which will likely eliminate their propagation so as to prevent further damage to the airfoil assembly 10. Hence, stress concentration of the airfoil assembly 10 at the service area S_{A} is believed to be reduced, thus increasing a lifespan of the airfoil assembly 10.

Once the volume of material V_{M} is removed via waterjet ablation process, the airfoil assembly 10 may be inspected to ensure that all defects 200 in the service area S_{A} were removed. If so, the airfoil assembly 10 may be allowed to proceed through the repair process described below, such that it may be subsequently put into service in a turbine engine, e.g., the engine from which it was extracted, or another engine. If not, the airfoil assembly 10 may be quarantined, such as for testing or destruction.

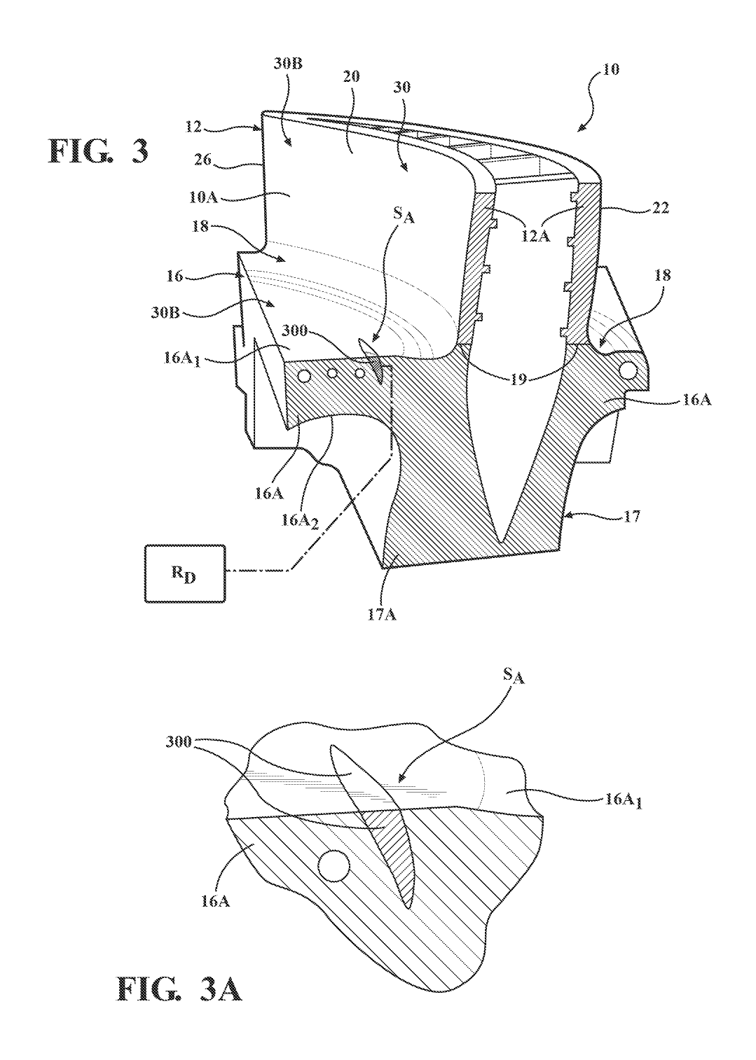

After the waterjet ablation process is completed, the service area S_{A} of the airfoil assembly 10 is repaired in a repair process. Referring to FIGS. 3 and 3A, repairing the service area S_{A} comprises performing a welding or brazing process with a repair device R_{D} to restore material 300 to the service area S_{A}. In accordance with an aspect of the invention, the only material restored to the airfoil assembly 10 after the waterjet ablation process is performed comprises the material 300, e.g., welding or brazing material, restored to the service area S_{A}, and any surface coatings applied to the airfoil assembly 10, such as TBC and/or bond coat(s).

Once the material 300 and any surface coatings are restored to the service area S_{A}, the airfoil assembly 10 may again be inspected to ensure that the volume of material V_{M} removed during the waterjet ablation process was entirely restored by the material 300 (and any surface coatings), and that the airfoil assembly 10 is again fit for use in a turbine engine. If so, the airfoil assembly 10 is able to be put into service in a turbine engine without any subsequent surface preparation, such as, for example, requiring affixation of a replacement coupon to the airfoil assembly 10. That is, since only the volume of material V_{M} was removed during the waterjet ablation process, as opposed to cutting the airfoil assembly portion off upstream from the defect 200, a replacement coupon or airfoil assembly portion does not need to be affixed to the airfoil assembly 10. If not, the airfoil assembly 10 may be quarantined, such as for testing or destruction.

The method described herein is believed to provide an efficient, cost effective way to repair airfoil assemblies 10 having defects, without adversely affecting the structural rigidity of the airfoil assembly 10.

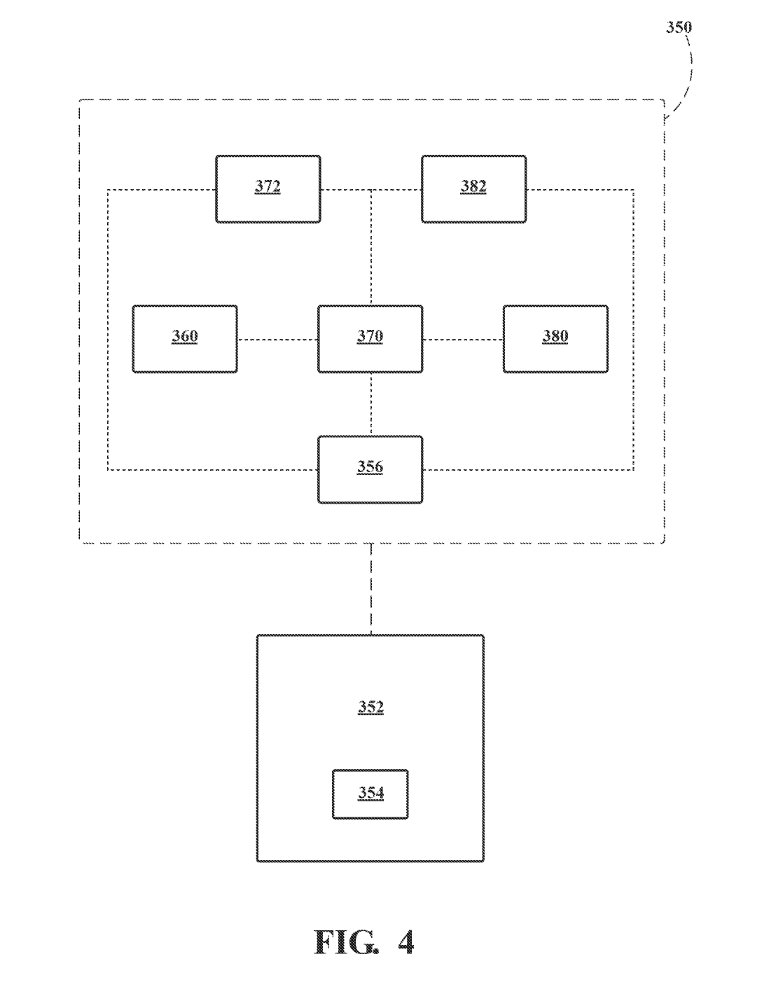

In accordance with another aspect of the present invention, referring to FIG. 4, a system 350 for servicing a component 352 used in a turbine engine, such as the airfoil assembly 10 described herein, to remove at least one defect 354 from the component 352 will now be described. The system 350 includes computer memory 356 that stores parameters of a plurality of components used in turbine engines. For example, the precise layout of select turbine engine components, e.g., turbine blades, vanes, etc., including dimensions, contours, material properties etc., may be analyzed and then stored in the computer memory 356.

A waterjet ablation device 360, such as the waterjet ablation machine W_{M} illustrated in FIG. 2 and described above, is controlled by a controller 370 that is in communication with the computer memory 356. The waterjet ablation device 360 is provided for removing a volume of material from a service area of the component 352 as described herein, wherein the volume of material includes at least one defect 354 and any oxides and contaminants located at the service area.

The controller 370 causes the waterjet ablation device 360 to perform a particular waterjet ablation process on the component 352 based on the stored parameters from the computer memory 356 for the particular component 352 being serviced. In this regard, an input device 372 in communication with the controller 370 is configured to receive coordinates of the material to be removed from the service area, e.g., from an operator, or from an automated machine that is configured to recognize the coordinates, e.g., from a scanned image of the component 352, which are then stored in the computer memory 356. The controller 370 instructs the waterjet ablation device 360 to remove the volume of material including the at least one defect 354 based on the coordinates of the material to be removed from the service area of the component 352.

The system 350 also comprises a repair device 380, such as the repair device R_{D} described above, e.g., comprising a welding or brazing device. The repair device 380 is controlled by the controller 370 to restore material to the service area after the volume of material is removed by the waterjet ablation device 360, as described above with reference to FIGS. 3 and 3A.

The system 350 may also comprise another input device 382 in communication with the controller 370, wherein the input device 382 is configured to receive coordinates of the material to be restored to the service area, e.g., from an operator, or from an automated machine that is configured to recognize the coordinates, e.g., from the previous or a subsequent scanned image of the component 352, which are stored in the computer memory 356. The coordinates of the material to be restored to the service area are used by controller 370 to cause the repair device 380 to restore material to the service area such that the component 352 can be placed into service in a turbine engine, as described herein.

It is understood that the system 350 could be automated, wherein the system 350 could select a particular waterjet ablation process to be performed based on the type of component to be serviced and the coordinates of the service area are provided to the controller 370 as described herein, wherein the controller 370 automatically performs the particular waterjet ablation process and the repair process according to the stored parameters in the computer member 356 for the component 352 to be serviced and according to the coordinates of the service area.

It is noted that the aspects of the invention described herein may be performed during a repair process, i.e., to repair/replace damaged airfoil assemblies 10, such as in situations where the base material 30 at or near the fillet area 18 has become damaged, e.g. cracked, during engine operation, such as due to overheating and oxidation.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

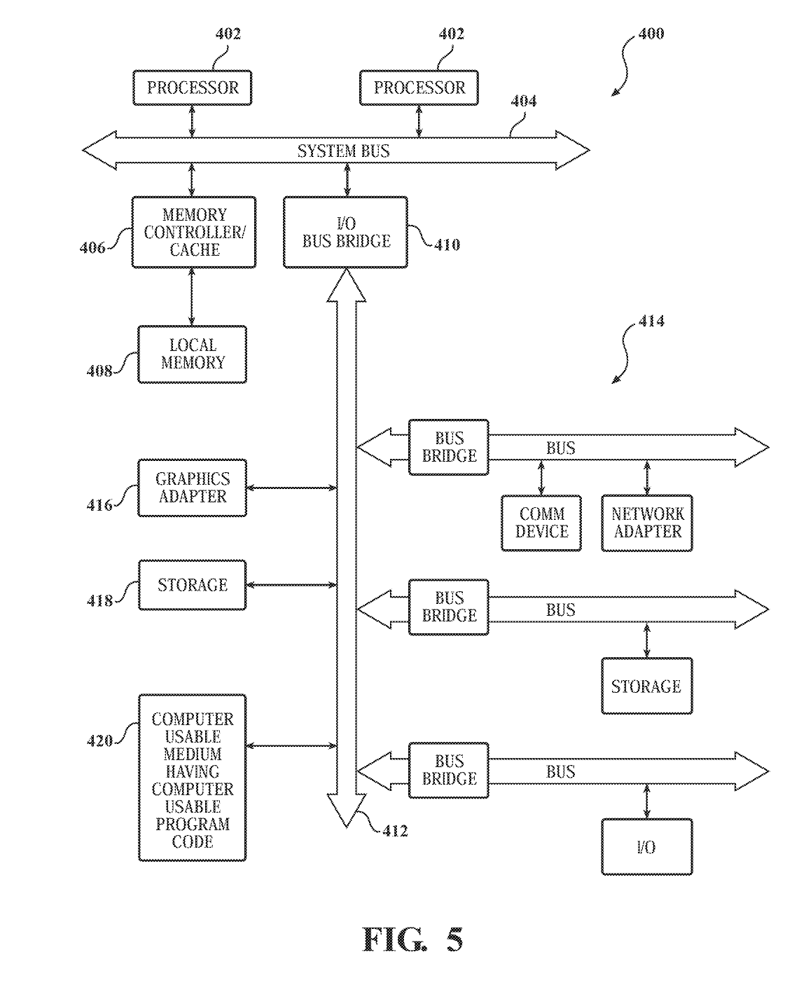

Referring now to FIG. 5, a block diagram of a data processing system is depicted in accordance with the present disclosure. A data processing system 400, such as may be utilized to implement the system 350 or aspects thereof, e.g., as set out in greater detail in FIG. 4, may comprise a symmetric multiprocessor (SMP) system or other configuration including a plurality of processors 402 connected to system bus 404. Alternatively, a single processor 402 or controller may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more busses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks to transmit and/or receive data in various formats.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIGS. 1-4.

The flowcharts and block diagrams in the figures illustrate the architecture, functionality, and operation of possible implementations of systems, methods and computer program products according to various aspects of the present disclosure. In this regard, each block in a flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While a particular embodiment of the present invention has been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for servicing a component used in a turbine engine to remove at least one defect from the component, the method comprising:
performing a waterjet ablation process to remove a volume of material from a service area of the component, the volume of material including at least one defect and any oxides and contaminants located at the service area; and
repairing the service area of the component, after performing the waterjet ablation process, by a welding or brazing process to restore material to the service area;
wherein the component is put into service in a turbine engine without requiring affixation of a replacement coupon to the component.

2. The method of claim 1, wherein the waterjet ablation process simultaneously removes the at least one defect from the service area and cleans the service area.

3. The method of claim 1, wherein the component comprises a platform from which at least one rotatable turbine blade extends, and the at least one defect comprises at least one crack extending into the platform.

4. The method of claim 3, wherein the at least one crack is located proximate to a fillet area located at a junction between the platform and a respective turbine blade.

5. The method of claim 1, wherein the volume of material removed from the service area is controlled during the waterjet ablation process within tolerances of about +/−0.001 inch.

6. The method of claim 5, wherein the waterjet ablation process is controlled such that it follows a direction of propagation of the at least one defect into the component.

7. The method of claim 1, wherein no surface preparation is performed to the service area after performing the waterjet ablation process and before repairing the service area of the component.

8. The method of claim 1, wherein parameters of a plurality of components used in turbine engines are analyzed and stored, and further comprising selecting a particular waterjet ablation process to be performed based on the type of component to be serviced, wherein a controller automatically performs the particular waterjet ablation process according to the stored parameters for the component to be serviced.

9. The method of claim 8, wherein coordinates corresponding to the volume of material to be removed from the service area of the component being serviced are input to the controller.

10. The method of claim 8, wherein the stored parameters of the component being serviced are used by the controller during the step of repairing the service area of the component to restore material to the service area.

11. The method of claim 1, wherein the only material restored to the component after the waterjet ablation process is performed comprises welding or brazing material restored to the service area and any surface coatings applied to the component.

12. The method of claim 1, wherein:
performing a waterjet ablation process comprises performing a waterjet ablation process along an orientation and direction of a crack;
the volume of material removed from the service area includes the entire crack; and
at least a portion of the crack orientation is at an angle transverse to a radial direction.

13. The method of claim 1, wherein the volume of material removed by the waterjet ablation process comprises a volume of material extending from an outer surface of the component toward but not up to an inner surface of the component such that a structural integrity of the component is maintained after the waterjet ablation process is performed.

14. The method of claim 1, wherein the service area is located at an outlet of a film cooling hole formed in an outer surface of the component.

15. A system for servicing a component used in a turbine engine to remove at least one defect from the component, the system comprising:
a computer memory that stores parameters corresponding to a plurality of turbine engine components;
a waterjet ablation device for removing a volume of material from a service area of a component being serviced, the volume of material including at least one defect and any oxides and contaminants located at the service area; and
a controller in communication with the computer memory that causes the waterjet ablation device to perform a particular waterjet ablation process on the component being serviced based on the stored parameters from the computer memory for the component being serviced.

16. The system of claim 15, further comprising an input device in communication with the controller configured to receive coordinates corresponding to the volume of material to be removed from the service area.

17. The system of claim 15, wherein the system further comprises a repair device comprising a welding or brazing device, the repair device configured to restore material to the service area after the volume of material is removed by the waterjet ablation device.

18. The system of claim 17, wherein the only material restored to the component after the volume of material is removed from the service area by the waterjet ablation device comprises welding or brazing material restored to the service area by the repair device and any surface coatings applied to the component.

19. The system of claim 18, wherein:
no additional surface preparation is performed to the service area after the waterjet ablation device removes the volume of material from the service area and before the repair device restores material to the service area; and
the component is put into service in a turbine engine without requiring affixation of a replacement coupon to the component.

20. The system of claim 17, further comprising:
an input device in communication with the controller configured to receive coordinates of the material to be restored to the service area;
wherein the coordinates of the material to be restored to the service area are used by the controller to cause the welding or brazing device to restore material to the service area.
